(19) United States
(12) Patent Application Publication
(10) Pub. No.: US 2010/0321412 A1
(43) Pub. Date: Dec. 23, 2010

(54) SYSTEM AND METHOD FOR DRIVING A LIQUID CRYSTAL DISPLAY

(75) Inventors: Meng-Tse Weng, Tainan (TW); Ying-Lieh Chen, Tainan (TW); Chien-Ru Chen, Tainan (TW)

Correspondence Address: BAKER & MCKENZIE LLP;PATENT DEPARTMENT, 2001 ROSS AVENUE, SUITE 2300, DALLAS, TX, 75201, US

(73) Assignee: HIMAX TECHNOLOGIES LIMITED, Tainan (TW)

(21) Appl. No.: 12/490,240

(22) Filed: Jun. 23, 2009

(51) Int. Cl. G09G 5/10; G09G 5/00

(52) U.S. Cl. 345/690; 345/204; 345/89

(57) ABSTRACT

The invention describes a system and method for driving a display device that includes an array of pixels respectively coupled with a plurality of scanning lines along a first direction and a plurality of data lines along a second direction, each of the data lines being adapted to transmit a driving signal that is amplified in a high-driving mode of operation. In one embodiment, the method comprises reading first digital data associated with a first pixel, reading second digital data associated with a second pixel, and based on the content of the first and second digital data determining whether one or more condition for generating a control signal to disable the high-driving mode of operation is satisfied.

### FIELD OF THE INVENTION

The invention generally relates to liquid crystal displays, and more particularly to a system and method for driving a liquid crystal display.

### DESCRIPTION OF THE RELATED ART

Conventionally, a liquid crystal display comprises a liquid crystal panel and a driver circuit coupled with the liquid crystal panel. The liquid crystal panel usually includes two substrates having opposite electrodes, a liquid crystal layer confined between the two substrates, and polarizer layers attached to outer surfaces of the two substrates. Light transmittance through the liquid crystal display panel is controlled by applying voltages to the electrodes, which generate an electric field across the liquid crystal layer to rearrange the liquid crystal molecules. A plurality of switching devices, such as thin film transistors (TFT), are connected with the pixel electrodes on one of the substrates for adequately switching and applying driving voltages applied by the driver circuit.

The driver circuit generally includes scanning drivers, data drivers, and a timing controller that issues various control signals and digital display data to the scanning and data drivers. The data drivers receive the digital display data, convert them into driving voltages corresponding to gray scale levels associated with the pixels, and then outputs the driving voltages through data lines. For large display panels, the conventional data drivers may also be adapted to work in a high-driving mode of operation, whereby driving voltages may be amplified through an amplifier circuit before they are outputted through the data lines to the TFTs. While the high-driving mode of operation may exhibit enhanced output slew rates, it is not without some downside effects. First, the driver circuit when operating in the high-driving mode consumes more power. In addition, the driven pixels may be subjected to a higher temperature stress as a result of higher driving signals.

Therefore, there is a need for a system that can drive a liquid crystal display in a more flexible manner and overcome at least the foregoing issues.

### SUMMARY OF THE INVENTION

The application describes a system and method for driving a liquid crystal display. In one embodiment, the method comprises reading first digital data associated with a first pixel, reading second digital data associated with a second pixel, and based on the content of the first and second digital data determining whether one or more condition for generating a control signal to disable the high-driving mode of operation is satisfied.

In another embodiment, a display device is described. The display device comprises a display panel including an array of pixels, and a driver unit coupled with the array of pixels through a plurality of scanning lines along a first direction and through a plurality of data lines along a second direction. Each of the data lines is adapted to transmit driving signals that are amplified in a high-driving mode of operation. The driver unit is configured to read first digital data associated with a first pixel, read second digital data associated with a second pixel, and based on the first and second digital data determine whether one or more condition for generating a control signal to disable the high-driving mode of operation is satisfied.

At least one advantage of the systems and methods described herein is the ability to control the high-driving mode of operation of the data driver in a more flexible manner, based on the evaluation of the gray scale levels obtained from digital display data associated with a pair of pixels. As a result, power consumption and temperature stress on the pixels can be reduced.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIG. 1 is a schematic diagram of a liquid crystal display according to one embodiment of the invention;

FIG. 2 is a schematic diagram of a data driver coupled with a high-driving control module according to one embodiment of the present invention;

FIG. 3 is a flowchart of method steps for determining when a control signal is to be generated for disabling a high-driving mode of operation, according to one embodiment of the present invention;

FIG. 4 is a flowchart of method steps for determining when a control signal is to be generated for disabling a high-driving mode of operation, according to another embodiment of the present invention.

### DETAILED DESCRIPTION OF THE EMBODIMENTS

The present application describes a system and method for driving a liquid crystal display. In one embodiment, the liquid crystal display comprises an array of pixels adapted to display an image based on control and driving signals provided by a driver unit. The driver unit includes a timing controller for receiving digital display data from a host device, at least one scan driver (also commonly called “gate driver” or “gate line driver”) that is coupled with multiple scanning lines (also commonly called “gate lines”) in the array of pixels, and a data driver (also commonly called “source driver” or “source line driver”) coupled with multiple data lines (also commonly called “source lines”) in the array of pixels. The data driver is adapted to output through the data lines driving signals that are amplified in a high-driving mode of operation. The driver unit is configured to determine in real-time whether one or more condition for disabling the high-driving mode of operation is met by evaluating digital display data associated with two pixels of one selected scanning line. The display device can thereby be driven in a more flexible manner for reducing power consumption and pixel thermal stress.

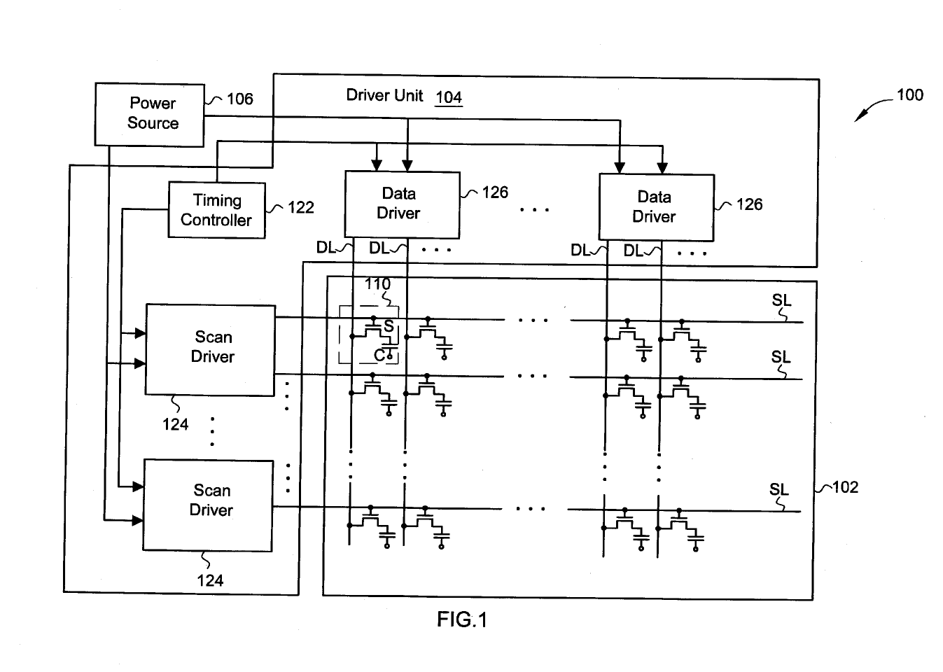

FIG. 1 is a schematic diagram of a liquid crystal display 100 according to one embodiment of the present invention. The liquid crystal display 100 includes a display panel 102, a driver unit 104, and a power source 106. The display panel 102 may be a reflective type, transmissive type, or transflective type liquid crystal display panel. The display panel 102 comprises an array of pixels 110 operable under control of the driver unit 104 for displaying an image. Each pixel 110 of the display panel 102 may include a switching element S, such as a thin-film transistor (TFT), which is coupled with a storage capacitor C and one or more pixel electrode (not shown). The driver unit 104, powered by the power source 106, includes a timing controller 122, one or more scan driver 124, and one or more data driver 126. The timing controller 122 receives digital display data from a host device (not shown), generates control signals for the scan drivers 124 and data drivers 126, and transmit the digital display data to the data drivers 126. The host device may include a computer graphics card, a computer central processing unit (CPU), a television adapter, or like display data sources. Each scan driver 124 is coupled with horizontal rows of pixels 110 through multiple scanning lines SL, and each data driver 126 is coupled with vertical columns of pixels 110 through multiple data lines DL. Each of the scan drivers 124 and data drivers 126 may be built from an integrated circuit (IC) chip that may be mounted on the display panel 102 according to various methods, such as through tape carrier packages (TCP), chip-on-glass (COG) technology, or the like. In alternate embodiments not shown, either of the scan or data drivers may also be integrated into a single IC chip.

During one horizontal synchronizing period, one scan driver 124 turns on the TFTs coupled along one selected scanning line SL, whereas each of the data drivers 126 applies driving signals through the data lines DL onto the turned-on TFTs to charge the associated capacitors C with display voltages corresponding to gray scale levels. Owing to a voltage difference between a common electrode (not shown) and the display electrodes applied with the display voltages latched by the storage capacitors C, liquid crystal molecules (not shown) in the display panel 102 are controllably oriented to achieve a desired light transmittance. Each horizontal row of pixels 110 is sequentially driven in this manner for displaying an image frame.

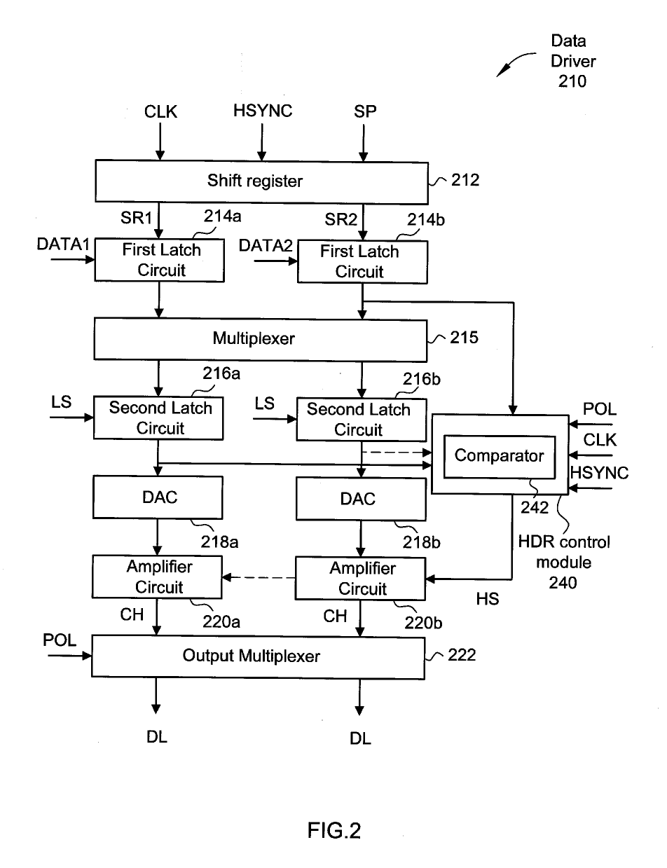

FIG. 2 is a schematic diagram of a data driver 210 according to one embodiment of the present invention. The data driver 210 comprises a shift register 212, first latch circuits 214a and 214b, a multiplexer 215, second latch circuits 216a and 216b, digital-to-analog converters (DAC) 218a and 218b, amplifier circuits 220a and 220b, and an output multiplexer 222. The shift register 212 receives a clock signal (CLK), a horizontal synchronizing signal (HSYNC) and a start pulse (SP) from the timing controller (FIG. 1), and sequentially outputs sampling pulses (SR1, SR2) to each of the first latch circuits 214a and 214b at prescribed timings. The first latch circuits 214a and 214b sequentially sample digital display data transmitted from the timing controller in synchronization with the sampling pulses, and holds these digital display data during one horizontal sampling period. For example, DATA1 designates digital display data associated with a first pixel received by the first latch circuit 214a, and DATA2 designates digital display data associated with a second pixel on the same selected scanning line received by the first latch circuit 214b. The digital display data may include encoded gray scale levels used for rendering a specific color of each pixel in a given color system such as the red (R), green (G) and blue (B) color system. In synchronization with a latch signal (LS), the second latch circuits 216a and 216b receive and latch in one time all the digital display data DATA1 and DATA2 transmitted from the first latch circuits 214a and 214b through the multiplexer 215. The digital display data held in the second latch circuits 216a and 216b may undergo amplitude modulation via a level shift circuit (not shown) before being processed through the DACs 218a and 218b. The DACs 218a and 218b convert the digital display data DATA1 and DATA2 into selected analog driving voltage signals corresponding to gray scale levels associated with the driven pixels. Each of the amplifier circuits 220a and 220b may comprise an operational amplifier that may be selectively enabled to operate in a high-driving mode. When the high-driving mode of operation is enabled, the amplifier circuits 220a and 220b amplify the driving voltage signals, which are then transmitted through output channels CH to the output multiplexer 222. When the high-driving mode of operation is disabled, the driving voltage signals are transmitted through the amplifier circuits 220a and 220b without amplification. The output multiplexer 222 selectively connects each of the output channels CH with either an odd-numbered or even-numbered data line DL based on a polarity control signal POL provided by the timing controller. One polarity control signal POL may be associated with each digital display data for configuring the driving voltage signal outputted through each data line DL. In one embodiment, the polarity control signal POL may be configured such that the driving voltage signals along the data lines DL have alternated polarity, such as in a dot-inverted driving mode, for example.

The high-driving mode of operation of each of the amplifier circuits 220a and 220b may be enabled or disabled according to a control signal HS that is selectively transmitted by a high-driving (HDR) control module 240 to each of the amplifier circuits 220a and 220b. In each horizontal synchronizing period, the HDR control module 240 reads digital display data DATA1 and DATA2 inputted to the data driver 210 for two adjacent pixels of the selected scanning line in synchronization with the horizontal synchronizing signal HSYNC, and determines whether one or more condition for generating a control signal to disable the amplifier circuits 220a and 220b is satisfied by evaluating these digital display data DATA1 and DATA2. The HDR control module 240 may be either built in the integrated circuit chip of the data driver 210, or provided separately.

As shown in FIG. 2, one embodiment of the HDR control module 240 comprise a comparator 242. The comparator 242 receives various control signals including a clock signal CLK, horizontal synchronizing signal HSYNC and polarity control signal POL, reads and compares a pair of digital display data DATA1 and DATA2 associated with two adjacent pixels of one selected scanning line, and outputs a control signal HS to the amplifier circuits 220a and 220b. The comparator 242 may access the digital display data DATA1 and DATA2 from various locations in the data driver 210, such as from the output of the first latch circuits 214a and 214b, or from the output of the second latch circuits 216a and 216b.

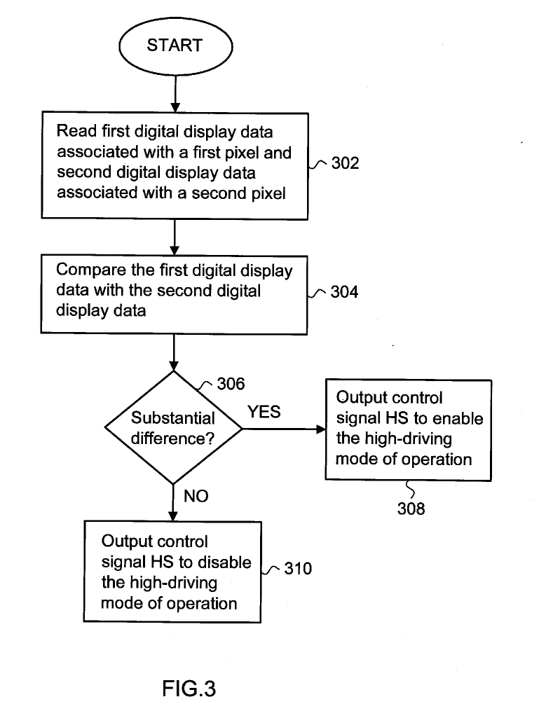

FIG. 3 is a flowchart of method steps performed by the HDR control module 240 for determining when a control signal is to be generated for disabling a high-driving mode of operation, according to one embodiment of the present invention. In initial step 302, the HDR control module 240 reads a pair of digital display data DATA1 and DATA2 associated with two adjacent pixels of one selected scanning line in synchronization with the received control signals, such as signals CLK and HSYNC. In step 304, the comparator 242 then compares the digital display data DATA1 against DATA2. In particular, as shown in step 306, the comparator 242 may determine whether there is a substantial difference between the two gray scale levels obtained from the digital display data DATA1 and DATA2. In one embodiment, a substantial difference may be found when a most superior bit (MSB) of the digital display data DATA1 differs from the MSB of digital display data DATA2 (i.e., one MSB is equal to 0 whereas the other MSB is equal to 1). In alternate embodiments, a substantial difference of gray scale levels may also be found when the difference between the digital display data DATA1 and DATA2 is greater than a preset value. When a substantial difference of gray scale levels is found, the HDR control module 240 in step 308 outputs a control signal HS that enables the high-mode of operation of the two amplifier circuits 220a and 220b. Consequently, driving voltage signals from the DACs 218a and 218b are amplified through the amplifier circuits 220a and 220b, and then outputted through the output channels CH.

On the other hand, when there is no substantial difference of gray scale levels, the HDR control module 240 in step 310 outputs a control signal HS that disables the high-driving mode of operation of the two amplifier circuits 220a and 220b. Consequently, driving voltage signals from the DACs 218a and 218b are transmitted through the disabled amplifier circuits 220a and 220b without amplification. In the same manner, the method steps 302 through 310 may be applied to evaluate multiple paired digital display data received by the data driver 210 for driving the entire array of pixels.

While the above-described method mainly disables the high-driving mode of operation when no substantial difference of gray scale levels occurs, alternate methods contemplated in the present invention may set forth additional conditions to determine when the high-driving mode of operation can be disabled or enabled.

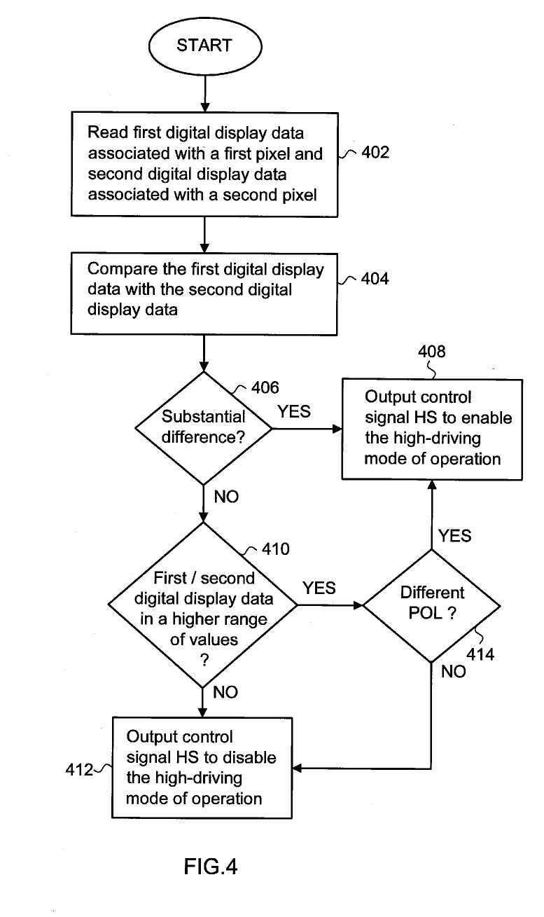

FIG. 4 is a flowchart of method steps performed by the HDR control module 240 for determining when a control signal is to be generated for disabling a high-driving mode of operation, according to another embodiment of the present invention. In initial step 402, the HDR control module 240 reads a pair of digital display data DATA1 and DATA2 associated with two pixels on one selected scanning line in synchronization with the received control signals, such as signals CLK and HSYNC. In step 404, the comparator 242 then compares the digital display data DATA1 against DATA2. In particular, as shown in step 406, the comparator 242 may determine whether there is a substantial difference between the two gray scale levels obtained from the digital display data DATA1 and DATA2. In one embodiment, a substantial difference of gray scale levels may be found when the MSB of digital display data DATA1 and the MSB of digital display data DATA2 have different values (i.e., one MSB is equal to 0 whereas the other MSB is equal to 1). In alternate embodiments, a substantial difference of gray scale levels may also be found when the difference between DATA1 and DATA2 is greater than a preset value. When a substantial difference of gray scale levels is found, the HDR control module 240 in step 408 outputs a control signal HS that enables the high-mode of operation of the two amplifier circuits 220a and 220b. Consequently, driving voltage signals from the DACs 218a and 218b are amplified through the amplifier circuits 220a and 220b, and then outputted through the output channels CH.

On the other hand, when no substantial difference of gray scale levels is found, the comparator 242 performs step 410 whereby it determines whether the gray scale levels obtained from the digital display data DATA1 and DATA2 are in a specific range of values, such as a certain higher or lower range of values. In one embodiment, the higher/lower range of values may be defined relative to a median of the entire range of permitted gray scale values according to the following manner: a gray scale level is found to be in the higher range when the MSB of the digital display data is equal to 1, and is in the lower range when the MSB of the digital display data is equal to 0. When the gray scale levels of the two digital display data DATA1 and DATA2 are not within the higher range of values (i.e. the MSB of both DATA1 and DATA2 is equal to 0, meaning that the two gray scale levels are in the lower range of values), the HDR control module 240 in step 412 outputs a control signal HS that disables the high-driving mode of operation of the amplifier circuits 220a and 220b. Consequently, driving voltage signals from the DACs 218a and 218b are transmitted through the disabled amplifier circuits 220a and 220b without amplification.

When the gray scale levels of the two digital display data DATA1 and DATA2 are within the upper range of values (i.e. the MSB of both DATA1 and DATA2 is equal to 1), the HDR control module 240 in step 414 then determines whether there is a difference in the polarity control signal POL associated with each of the digital display data DATA1 and DATA2. When a difference in the polarity control signal POL is detected, the HDR control module 240 performs step 408 whereby it outputs a control signal HS that enables the high-driving mode of operation of the circuit amplifiers 220a and 220b. When the polarity control signal POL is the same for the two digital display data DATA1 and DATA2, the HDR control module 240 performs step 412 whereby it outputs a control signal HS that disables the high-driving mode of operation of the circuit amplifiers 220a and 220b.

It is worth noting that the systems and methods described above may be applied for evaluating digital display data associated with multiple pairs of pixels along the selected scanning line. Furthermore, alternate embodiments may set other types of conditions more or less restrictive for determining when to disable or enable the high-driving mode, so that the high-driving mode of operation of the data driver can be controlled in a more flexible manner.

While the aforementioned description illustrate embodiments where the HDR control module is coupled with one data driver, other hardware configurations may also be suitable. For example, in some variant embodiments, the HDR control module may also be integrated within the timing controller to access and evaluate the digital display data. In this case, the timing controller may be configured to transmit the control signal to the data driver for either enabling or disabling the high-driving mode of operation of the amplifier circuits.

The above-described systems and methods are therefore able to control the high-driving mode of operation of the data driver in a more flexible manner by evaluating the gray scale levels from the content of digital display data associated with a pair of pixels of one selected scanning line. Power consumption and temperature stress on the driven pixels can thereby be reduced.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the invention as defined in the claims that follow.

What is claimed is:

1. A method for driving a display device, wherein the display device comprises an array of pixels coupled with a plurality of scanning lines along a first direction and a plurality of data lines along a second direction, each of the data lines being adapted to transmit a driving signal that is amplified in a high-driving mode of operation, the method comprising:
reading first digital data associated with a first pixel;
reading second digital data associated with a second pixel; and
based on the content of the first and second digital data, determining whether one or more condition for generating a control signal to disable the high-driving mode of operation is satisfied.

2. The method according to claim 1, wherein the first pixel and the second pixel are two adjacent pixels of one selected scanning line.

3. The method according to claim 1, wherein the step of determining whether one or more condition for generating a control signal to disable the high-driving mode of operation is satisfied comprises comparing a first gray scale level obtained from the first digital data with a second gray scale level obtained from the second digital data.

4. The method according to claim 3, wherein one condition for generating a control signal to disable the high-driving mode of operation is satisfied when the first gray scale level and the second gray scale level are within a lower range of values relative to a median gray scale value.

5. The method according to claim 3, wherein one condition for generating a control signal to disable the high-driving mode of operation is satisfied when no substantial difference between the first and second gray scale level occurs.

6. The method according to claim 5, wherein the occurrence of a substantial difference between the first and second gray scale levels is found when a first most superior bit of the first digital data and a second most superior bit of the second digital data have different binary values.

7. The method according to claim 5, further comprising generating a control signal for enabling the high-driving mode of operation when a substantial difference between the first and second gray scale levels occurs.

8. The method according to claim 1, wherein the step of determining whether one or more condition for generating a control signal to disable the high-driving mode of operation is satisfied further comprises evaluating a polarity control signal associated with each of the first and second digital data.

9. The method according to claim 8, wherein one condition for generating a control signal to disable the high-driving mode of operation is satisfied if:
a first gray scale level obtained from the first digital data and a second gray scale level obtained from the second digital data are within an upper range of values relative to a median gray scale value; and
the polarity control signal associated with each of the first and second digital data is identical.

10. The method according to claim 8, further comprising generating a control signal for enabling the high-driving mode of operation if:
a first gray scale level obtained from the first digital data and a second gray scale level obtained from the second digital data are within an upper range of values relative to a median gray scale value; and
the polarity control signal associated with the first digital data differs from the polarity control signal associated with the second digital data.

11. A display device comprising:
a display panel including an array of pixels; and
a driver unit coupled with the array of pixels through a plurality of scanning lines along a first direction and through a plurality of data lines along a second direction, each of the data lines being adapted to transmit a driving signal that is amplified in a high-driving mode of operation,
wherein the driver unit is configured to
read first digital data associated with a first pixel;
read second digital data associated with a second pixel; and
based on the content of the first and second digital data, determine whether one or more condition for generating a control signal to disable the high-driving mode of operation is satisfied.

12. The display device according to claim 11, wherein the first pixel and the second pixel are two adjacent pixels of one selected scanning line.

13. The display device according to claim 11, wherein the driver unit is configured to determine whether one or more condition for generating a control signal to disable the high-driving mode of operation is satisfied by comparing a first gray scale level obtained from the first digital data with a second gray scale level obtained from the second digital data.

14. The display device according to 13, wherein one condition for generating a control signal to disable the high-driving mode of operation is satisfied when the first gray scale level and the second gray scale level are within a lower range of values relative to a median gray scale value.

15. The display device according to claim 13, wherein one condition for generating a control signal to disable the high-driving mode of operation is satisfied when no substantial difference between the first and second gray scale levels occurs.

16. The display device according to claim 15, wherein the occurrence of a substantial difference between the first and second gray scale levels is found when a first most superior bit of the first digital data and a second most superior bit of the second digital data have different binary values.

17. The display device according to claim 15, wherein the driver unit is further configured to generate a control signal for enabling the high-driving mode of operation when a substantial difference between the first and second gray scale levels occurs.

18. The display device according to claim 11, wherein the driver unit is configured to determine whether one or more condition for generating a control signal to disable the high-driving mode of operation is satisfied by further evaluating a polarity control signal associated with each of the first and second digital data.

19. The display device according to claim 18, wherein one condition for generating a control signal to disable the high-driving mode of operation is satisfied if:
a first gray scale level obtained from the first digital data and a second gray scale level obtained from the second digital data are within an upper range of values relative to a median gray scale value; and
the polarity control signal associated with each of the first and second data is identical.

20. The display device according to claim 18, wherein the driver unit is further configured to generate a control signal for enabling the high-driving mode of operation if:
a first gray scale level obtained from the first digital data and a second gray scale level obtained from the second digital data are within an upper range of values relative to a median gray scale value; and
the polarity control signal associated with the first digital data differs from the polarity control signal associated with the second digital data.
